(19) United States
(12) Patent Application Publication
(10) Pub. No.: US 2025/0005093 A1
(43) Pub. Date: Jan. 2, 2025

(54) OPTIMIZING ONLINE USER INTERACTION USING CONSTRAINTS

(71) Applicant: Microsoft Technology Licensing, LLC, Redmond, WA (US)

(72) Inventors: Ayan Acharya, Santa Clara, CA (US); Siyuan Gao, San Mateo, CA (US); Kinjal Basu, Stanford, CA (US); Ankan Saha, San Francisco, CA (US); Sathiya K. Selvaraj, Sunnyvale, CA (US); Parag Agrawal, Mountain View, CA (US); Borja Ocejo Elizondo, Chicago, IL (US); Aman Gupta, San Jose, CA (US); Rahul Mazumder, Sommerville, MA (US)

(21) Appl. No.: 18/236,062

(22) Filed: Aug. 21, 2023

Related U.S. Application Data
(60) Provisional application No. 63/524,587, filed on Jun. 30, 2023.

(51) Int. Cl. G06F 16/9536; G06Q 50/00

(52) U.S. Cl. CPC G06F 16/9536; G06Q 50/01

(57) ABSTRACT

A method may comprise, for each one of a plurality of destination users, computing a score using a first function based on a probability of a source user performing a source action directed towards the destination user, a second function based on a probability of the destination user performing a destination action in response to the source action, and a third function based on a measure of interaction by the destination user with an online service to result from the destination action being performed by the destination user. The score for inactive users may be boosted using an optimization algorithm with a first constraint comprising a maximum threshold number of the inactive users to display as recommendations to the source user and a second constraint comprising a minimum threshold number of the inactive users for which the source user to perform the source action.

### CROSS-REFERENCE TO RELATED APPLICATIONS

This application claims the benefit of priority, under 35 U.S.C. Section 119(e), to U.S. Provisional Application No. 63/524,587, filed on Jun. 30, 2023, entitled, “OPTIMIZING ONLINE USER INTERACTION USING CONSTRAINTS”, which is hereby incorporated by reference in its entirety as if set forth herein.

### TECHNICAL FIELD

The present application relates generally to optimizing user interaction with an online service by boosting recommendations of inactive users using constraints.

### BACKGROUND

Online services, such as those that implement social networks, significantly influence how people interact over the Internet with their peers. Online services that rank content for distribution (e.g., newsfeeds, stories, and notifications) and are related to edge recommendations (e.g., connect to members, follow celebrities or groups or hashtags) optimize the experience of active users on such platforms. Effective edge-building and network formation are paramount for building proper connections and nurturing richer conversations between members in such an ecosystem. Edge-building recommendation systems assist consumers in growing their connection network efficiently. These systems generally deal with multiple objectives, such as network growth, construction of a quality network, and retention improvement, to name a few. These objectives are often at odds with each other.

Unfortunately, a disproportionately large number of users on such platforms are not proactive about forming the right connections. The abundance of interactions from the more active users usually overwhelms the logged data. Therefore, models trained based on such biased data endorse forming connections between active users, reinforcing the rich-get-richer cycle. Consequently, the inactive users receive poor content liquidity and quickly lose interest in the platform.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating functional components of an online service, in accordance with an example embodiment.

FIG. 2 illustrates a graphical user interface (GUI) in which recommendations for performing a particular source user action directed towards destination users are displayed to a source user, in accordance with an example embodiment.

FIG. 3 illustrates a GUI in which a selectable option to perform a particular destination user action is displayed to a destination user as a result of the source user performing the particular source user action, in accordance with an example embodiment.

FIG. 4 is a flowchart illustrating a method of optimizing user interaction with an online service by boosting recommendations of inactive users using constraints, in accordance with an example embodiment.

FIG. 5 is a block diagram illustrating an architecture of a recommendation system, in accordance with an example embodiment.

FIG. 6 is a block diagram illustrating a software architecture, in accordance with an example embodiment.

FIG. 7 illustrates a diagrammatic representation of a machine in the form of a computer system within which a set of instructions may be executed for causing the machine to perform any one or more of the methodologies discussed herein, in accordance with an example embodiment.

### DETAILED DESCRIPTION

### I. Overview

In the following description, for purposes of explanation, numerous specific details are set forth in order to provide a thorough understanding of example embodiments. It will be evident, however, to one skilled in the art that the present embodiments may be practiced without these specific details.

Several scientific and industrial disciplines benefit from large-scale formulations of underlying problems. Such problems also abound in the Internet industry in different forms ranging from optimizing the volume of e-mails sent to users and matching entities to consumers in an m-sided marketplace. Solving these large-scale problems using generic or commercial solvers is impossible. The problem of recommending other users with whom a user should connect and form an edge involves billions of variables beyond the capacity of generic solvers that use simplex or interior point methods. Unless the problem structure is carefully exploited, these methods can become prohibitively expensive for large-scale applications.

Logged feedback data in recommender systems are typically biased for reasons, such as positional representation, specific pro-motions, homophily, popularity, and contemporaneity. Such biases often encourage rich-get-richer behavior, which is sometimes referred to and recognized as the Matthew effect. The corresponding bias in user recommendation systems arises because of the lack of representation of the inactive users in the logged data. As a result, the interactions of the active users overwhelm the data used to train the ranking models. The relevance of the inactive users is systematically degraded over time, encouraging connections to be formed only among active users, thereby hindering the effectiveness and functioning of the online service.

The above-discussed technical problem of recommendation systems for online services being biased against inactive users is addressed by one or more example embodiments disclosed herein, in which a specially-configured computer system is configured to optimize user interaction with an online service by boosting recommendations of inactive users using an optimization algorithm. The term “inactive user” is used in the present disclosure to refer to a user that has been identified based on one or more criteria of inactivity, such as the user having not interacted with an online service within a threshold amount of time.

In some example embodiments, the computer system is configured to, for each one of a plurality of destination user candidates, compute a score using a first objective function based on a probability of a source user performing a particular source user action directed towards the destination user candidate, a second objective function based on a probability of the destination user candidate performing a particular destination user action in response to the particular source user action, and a third objective function based on a predicted measure of interaction by the destination user candidate with an online service to result from the particular destination user action being performed by the destination user candidate. The plurality of destination user candidates may comprise anywhere between two destination user candidates and all potential destination user candidates of the online service. The computer system identifies a set of users, also referred to herein as a plurality of inactive users, from amongst the plurality of destination user candidates based on a determination that an amount of time that has passed since each user of the set of users has interacted with an online service satisfies a minimum threshold value, and then boosts the score for the user using an optimization algorithm. The computer system may boost the score for the user using the optimization algorithm along with a first constraint and a second constraint to optimize the first objective function, the second objective function, and the third objective function, where the first constraint comprises a maximum threshold number of the set of users to display as recommendations to the source user, and the second constraint comprises a minimum threshold number of the set of users for which the source user to perform the particular source user action.

In some example embodiments, the computer system selects a subset of the plurality of destination user candidates from the plurality of destination user candidates based on the scores of the plurality of destination user candidates, where the selected subset includes at least one user of the set of users based on the boosting of the score of the at least one user of the set of users. The computer system may then cause a recommendation for each one of the selected subset of the plurality of destination user candidates to be displayed on a computing device of the source user. The recommendation comprises a recommendation to perform the particular source user action for the one of the selected subset of destination user candidates.

Features of the present disclosure are discussed herein in the context of edge or connection building, where the particular source user action comprises submitting an invitation to connect via a social networking service and the particular destination user action comprises accepting an invitation to connect via the social networking service. However, the features of the present disclosure may be used in other contexts as well, where other types of source user actions and destination user actions are used.

### II. Detailed Example Embodiments

The methods or embodiments disclosed herein may be implemented as a computer system having one or more components implemented in hardware or software. For example, the methods or embodiments disclosed herein may be embodied as instructions stored on a machine-readable medium that, when executed by one or more hardware processors, cause the one or more hardware processors to perform the instructions.

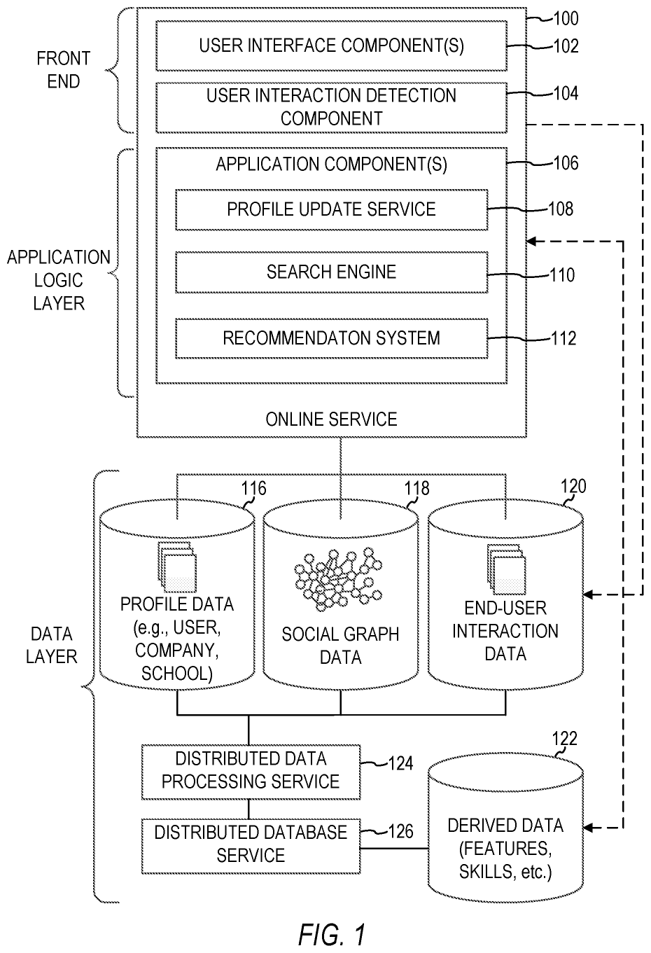

FIG. 1 is a block diagram illustrating functional components of an online service 100, in accordance with an example embodiment. As shown in FIG. 1, a front end may comprise one or more user interface components (e.g., a web server) 102, which receives requests from various client computing devices and communicates appropriate responses to the requesting client devices. For example, the user interface component(s) 102 may receive requests in the form of Hypertext Transfer Protocol (HTTP) requests or other web-based API requests. In addition, a user interaction detection component 104, sometimes referred to as a click tracking service, may be provided to detect various interactions that end-users have with different applications and services, such as those included in the application logic layer of the online service 100. As shown in FIG. 1, upon detecting a particular interaction, the user interaction detection component 104 logs the interaction, including the type of interaction and any metadata relating to the interaction, in an end-user interaction data database 120. Accordingly, data from this database 120 can be further processed to generate data appropriate for training one or more models (e.g., machine learning models, optimization models), and in particular, for training models to rank a set of skills for an end-user.

An application logic layer may include one or more application components 106, which, in conjunction with the user interface component(s) 102, generate various user interfaces (e.g., web pages) with data retrieved from various data sources in a data layer. Consistent with some embodiments, individual application components 106 implement the functionality associated with various applications and/or services provided by the online service 100. For instance, as illustrated in FIG. 1, the application logic layer includes a variety of applications and services to include a profile update service 108, a search engine 110, and a recommendation system 112. The various applications and services illustrated as part of the application logic layer are provided as examples and are not meant to be an exhaustive listing of all applications and services that may be integrated with and provided as part of the online service 100. For example, although not shown in FIG. 1, the online service 100 may also include a job hosting service via which end-users submit job postings that can be searched by end-users, and/or recommended to other end-users. As end-user's interact with the various user interfaces and content items presented by these applications and services, the user interaction detection component 104 detects and tracks the end-user interactions, logging relevant information for subsequent use.

As shown in FIG. 1, the data layer may include several databases, such as a profile database 116 for storing profile data, including both end-user profile data and profile data for various organizations (e.g., companies, schools, etc.). Consistent with some embodiments, when a person initially registers to become an end-user of the online service 100, the person will be prompted by the profile update service 108 to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 116. Similarly, when a representative of an organization initially registers the organization with the online service 100, the representative may be prompted to provide certain information about the organization. This information may be stored, for example, in the profile database 116, or another database (not shown).

Once registered, an end-user may invite other end-users, or be invited by other end-users, to connect via the online service 100. A “connection” may constitute a bilateral agreement by the end-users, such that both end-users acknowledge the establishment of the connection. Similarly, with some embodiments, an end-user may elect to “follow” another end-user. In contrast to establishing a connection, the concept of “following” another end-user typically is a unilateral operation and, at least with some embodiments, does not require acknowledgement or approval by the end-user that is being followed. When one end-user follows another, the end-user may receive status updates relating to the other end-user, or other content items published or shared by the other end-user user who is being followed. Similarly, when an end-user follows an organization, the end-user becomes eligible to receive status updates relating to the organization as well as content items published by, or on behalf of, the organization. For instance, content items published on behalf of an organization that an end-user is following will appear in the end-user's personalized feed, sometimes referred to as a content feed or news feed. In any case, the various associations and relationships that the end-users establish with other end-users, or with other entities (e.g., companies, schools, organization) and objects (e.g., metadata hashtags (“#topic”) used to tag content items), are stored and maintained within a social graph in a social graph database 118.

As end-users interact with the various content items that are presented via the applications and services of the online service 100, the end-users' interactions and behaviors (e.g., content viewed, links or buttons selected, messages responded to, job postings viewed, etc.) are tracked by the user interaction detection component 104, and information concerning the end-users' activities and behaviors may be logged or stored, for example, as indicated in FIG. 1 by the end-user interaction data database 120.

Consistent with some embodiments, data stored in the various databases of the data layer may be accessed by one or more software agents or applications executing as part of a distributed data processing service 124, which may process the data to generate derived data. The distributed data processing service 124 may be implemented using Apache Hadoop® or some other software framework for the processing of extremely large data sets. Accordingly, an end-user's profile data and any other data from the data layer may be processed (e.g., in the background or offline) by the distributed data processing service 124 to generate various derived profile data. As an example, if an end-user has provided information about various job titles that the end-user has held with the same organization or different organizations, and for how long, this profile information can be used to infer or derive an end-user profile attribute indicating the end-user's overall seniority level or seniority level within a particular organization. This derived data may be stored as part of the end-user's profile or may be written to another database.

In addition to generating derived attributes for end-users' profiles, one or more software agents or applications executing as part of the distributed data processing service 124 may ingest and process data from the data layer for the purpose of generating training data for use in training various machine-learned models, and for use in generating features for use as input to the trained models. For instance, profile data, social graph data, and interaction data, as stored in the databases of the data layer, may be ingested by the distributed data processing service 124 and processed to generate data properly formatted for use as training data for training machine-learned models for constructing a taxonomy graph of entities. Once the derived data and features are generated, they are stored in a database 122, where such data can easily be accessed via calls to a distributed database service 124.

In some example embodiments, the recommendation system 112 may be configured to operate as a bidirectional edge-building recommendation system where users are recommended to other users with whom they can connect. When a connection is made between users of the online service 100, the users can access content from each other through distributional channels, such as feeds and notifications. Such a recommendation framework involves the computation of three different scores: (1) a score based on the probability of an invitation being sent from the source user (the user being shown the edge recommendation) to the destination user (the user with whom the source user is being recommended to form a connection), (2) a score based on the probability of accepting the invitation from the source user by the destination user, and (3) a score based on the value of the edge, if formed, between the source user and the destination user. A final relevance score that may be used to determine which users to recommend for connection may be framed as a composite ranker consisting of a combination of the scores mentioned above. This combination score is a solution to a Lagrangian dual problem of a constrained optimization, where parameters of the scoring model used to compute the combination of the three scores discussed above are chosen from running multiple online experiments. The parameters may comprise weights to be applied to features of the scoring model, such as one weight to be applied to the score that is based on the probability of an invitation being sent and another weight to be applied to the score that is based on the value of the edge. Other types of parameters for weighting different features of the scoring model may be used as well.

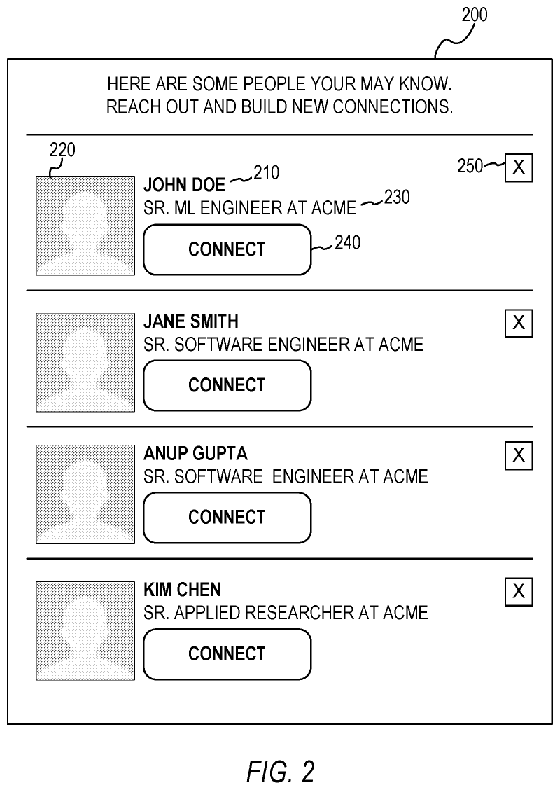

FIG. 2 illustrates a graphical user interface (GUI) 200 in which recommendations for performing a particular source user action directed towards destination users are displayed to a source user, in accordance with an example embodiment. In the example shown in FIG. 2, the recommendations comprise recommendations of destination users for whom to send invitations to connect on a social networking service. In FIG. 2, the GUI 200 is presented to a source user and displays selectable options to send invitations to destination users of to become connections on the social networking service. Each selectable option may comprise an identification 210 of the destination user, an image 220 associated with a profile of the destination user, one or more attributes 230 of the destination user (e.g., job position, company), and a selectable user interface element 240 (e.g., a clickable button) configured to cause a user-to-user message (e.g., an invitation to connect) to be transmitted to the other user or to cause another type of source user action to be performed. Each selectable option may also comprise another selectable user interface element 250 configured to reject or otherwise dismiss the corresponding recommendation so as to indicate an instruction by the source user not to perform the source user action for the destination user of the corresponding recommendation.

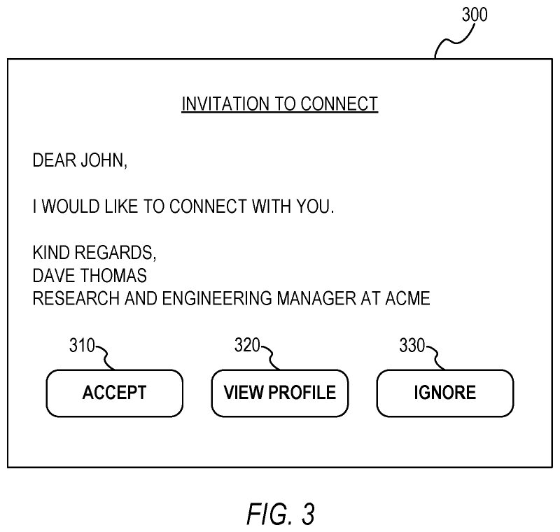

FIG. 3 illustrates a GUI 300 in which a selectable option to perform a particular destination user action is displayed to a destination user as a result of the source user performing the particular source user action, in accordance with an example embodiment. In FIG. 3, an invitation to connect with a source user on a social networking service is displayed to a destination user. As seen in FIG. 3, the invitation to connect may comprise an explanation that the destination user is being invited by a particular user to connect on the social networking service, along with a selectable user interface element 310 (e.g., an “ACCEPT” button) for accepting the invitation to connect, which is configured to cause the social networking service to generate and store a connection between the source user and the destination user in response to, or otherwise based on, the selection of the selectable user interface element 310. The invitation may also comprise a selectable user interface element 320 (e.g., a “VIEW PROFILE” button) configured to cause a profile of the source user who sent the invention to be displayed to the destination user in response to, or otherwise based on, its selection, as well as a selectable user interface element 330 (e.g., an “IGNORE” button) configured to decline or reject the invitation to connect in response to, or otherwise based on, its selection.

The probability scores and edge-value may be modelled using supervised learning frameworks. The recommendation system 112 may train separate models on logged interaction data to derive each of these scores. These models are referred to as first-pass-rankers (FPRs), as they produce the first set of relevance scores for a given source-destination pair. In particular, the FPR for the score based on the probability of an invitation being sent from the source user to the destination user may optimize the source-side experience to encourage users to send out more invitations to members they may want to connect with. On the other hand, the FPR for the score based on the probability of accepting the invitation from the source user by the destination user may address the receiver-side behavior so that the receivers are encouraged to accept more invitations from sources they would like to connect to. The FPR for score based on the value of the edge between the source user and the destination user represents a utility that prioritizes connections that may lead to increased destination session activity.

The current composite ranking formulation has distinct disadvantages. Initially, the edge-building recommendation problem was designed to optimize for the source-side objectives. Such a strategy exacerbates the rich-get-richer problem, with most sources seeing the popular candidates as recommendations. Furthermore, the existing system fails to incorporate evolving practical business constraints to adapt these recommendations. The bias in the training set aggravates the rich-get-richer problem, where active users receive more invitations, and inactive users lose out on opportunities to connect. This phenomenon results in a cycle of degrading the inactive user's experience. This problem may be formulated as a two-sided marketplace where the recommendation system 112 simultaneously optimizes the objectives of both the source and destination users, providing a more equitable distribution of exposure to the inactive users, leading to an enhanced user experience that incentivizes them to interact with the platform.

Finally, scoring relevance with hand-tuned parameters, such as the weights to be applied to features of the scoring model for computing the combination of the three scores, often leads to a sub-optimal ranking and loss in developers' productivity, as the number of different configurations that need to be evaluated during optimization is extremely large. Since these configurations need to be evaluated online, they block traffic from online serving. Each experiment must run for a certain number of days to ensure a statistically significant trend, leading to expensive human labor and computation costs. Hyper-parameter optimization techniques can be used for solving such problems, but they often require a non-trivial implementation to work in conjunction with legacy systems. The optimization formulation of the present disclosure can be extended to solve this problem.

At a high level, the proposed framework maximizes the expected combined relevance score over all source-destination pairs while enforcing a first constraint that the total measure of impressions associated with the recommendations for the inactive users by each source member is less than a given value, as well as a second constraint that the expected number of invites sent to each inactive user does not drop below a certain threshold.

Using the above proposed framework, the recommendation system 112 may populate the online recommendations of the source users with candidates in a way to facilitate a more equitable distribution of connections, using the first constraint to ensure that no user gets to monopolize the system by sending too many invites, so the rich-gets-richer problem is scrupulously mitigated. The second constraint is used by the framework to ensure that each inactive user receives a minimum number of invitations. As will be explained below, the dual variables corresponding to the second set of constraints contribute to personalized weights and cater to customized recommendations. To make the problem strongly convex, the recommendation system 112 may use a linear program solver to optimize the problem.

Promoting all the inactive users in the ecosystem is computationally infeasible and liquidity-wise improbable. Many users are not responsive and hence cannot be resurrected easily in the social network. The recommendation system 112 may consider different gradations of inactive users, based on user behaviour like frequency of visits, as well as based on model estimates like the propensity of these users to visit and engage with the platform if they are provided incentives, such as more invitations to connect, and use it to finally populate the set of destination users to recommend to the source user.

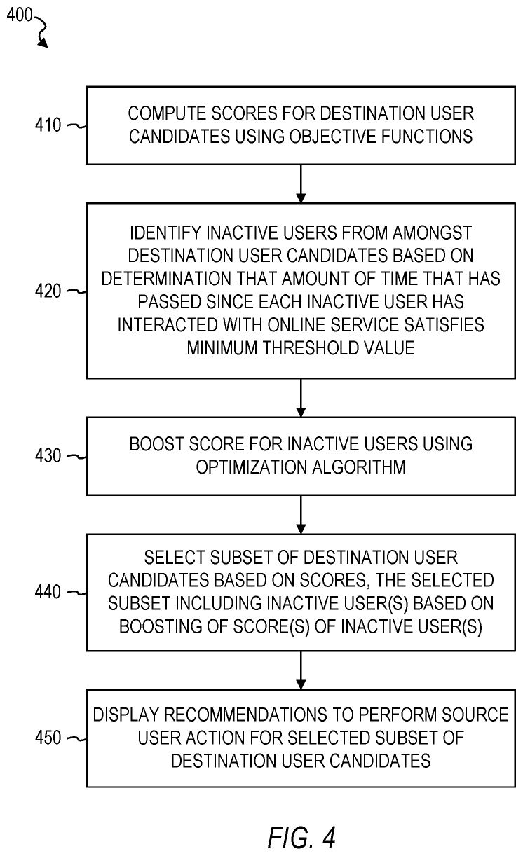

FIG. 4 is a flowchart illustrating a method 400 of optimizing user interaction with an online service by boosting recommendations of inactive users using constraints, in accordance with an example embodiment. The method 400 can be performed by processing logic that can comprise hardware (e.g., circuitry, dedicated logic, programmable logic, microcode, etc.), software (e.g., instructions run on a processing device), or a combination thereof. In one implementation, the method 400 is performed by the online service 100 of FIG. 1, or any combination of one or more of its components (e.g., the recommendation system 112), as described above.

At operation 410, the online service 100, for each one of a plurality of destination user candidates, computes a score using a first objective function based on a probability of a source user performing a particular source user action directed towards the destination user candidate, a second objective function based on a probability of the destination user candidate performing a particular destination user action in response to the particular source user action, and a third objective function based on a predicted measure of interaction by the destination user candidate with an online service to result from the particular destination user action being performed by the destination user candidate. The particular source user action may comprise submitting an invitation to connect via a social networking service, and the particular destination user action may comprise accepting an invitation to connect via the social networking service. However, other types of source user actions and destination user actions are also within the scope of the present disclosure.

In some example embodiments, the probability of the source user performing the particular source user action directed towards the destination user candidate is based on at least one of profile data of the source user, interaction data indicating interactions of the source user with the online service, or social graph data of the source user. The probability of the source user performing the particular source user action directed towards the destination user candidate may be computed based on behavior data of the source user indicating whether the source user performed the particular source user action directed towards other users that have been determined to have profile data similar to the profile data of the destination user candidate. For example, the more often that the source user performed the particular source user action directed towards users that are determined to be similar to the destination user candidate, the higher the probability of the source user performing the particular source user action directed towards the destination user candidate. The probability may further increase if the destination user candidate is connected to the source user in a social graph of the online service 100. The probability of the source user performing the particular source user action directed towards the destination user candidate may be based on other factors, as well.

In some example embodiments, the probability of the destination user candidate performing the particular destination user action in response to the particular source user action is based on at least one of profile data of the destination user candidate, interaction data indicating interactions of the destination user candidate with the online service, or social graph data of the destination user candidate. The probability of the destination user candidate performing the particular destination user action in response to the particular source user action may be computed based on behavior data of the destination user candidate indicating whether the destination user candidate performed the particular destination user action in response to the particular source user action performed by other users that have been determined to have profile data similar to the profile data of the source user. For example, the more often that the destination user candidate performed the particular destination user action in response to the particular source user action being performed by users that are determined to be similar to the source user, the higher the probability of the destination user candidate performing the particular destination user action in response to the particular source user action. The probability may further increase if the source user is connected to the destination user candidate in a social graph of the online service 100. The probability of the destination user candidate performing the particular destination user action in response to the particular source user action may be based on other factors as well.

In some example embodiments, the predicted measure of interaction by the destination user candidate with the online service to result from the particular destination user action being performed by the destination user candidate is based on a number of sessions between the destination user candidate and the online service within a specified period of time after the particular destination user action was performed by the destination user candidate. For example, the predicted measure of interaction may be computed based on the number of times the destination user candidate navigated to a page (e.g., a home page, a profile page, a landing page) of the online service 100 within four weeks of performing the particular destination user action, such as within four weeks of the destination user accepting an invitation to connect with another user. The predicted measure of interaction by the destination user candidate with the online service to result from the particular destination user action being performed by the destination user candidate may be based on other factors as well.

At operation 420, the online service 100 identifies a set of users (a plurality of inactive users) from amongst a plurality of destination user candidates based on a determination that an amount of time that has passed since each user of the set of users has interacted with an online service satisfies a minimum threshold value. In some example embodiments, the identifying of the set of users from amongst the plurality of destination user candidates is further based on a determination that the amount of time that has passed since each user of the set of users has interacted with the online service 100 satisfies a maximum threshold value. By filtering out destination user candidates that have not interacted with the online service 100 within the maximum threshold amount of time, the online service 100 avoids boosting destination user candidates that are unlikely to be prompted to interact with the online service 100. For example, users who have not interacted with the online service 100 in the last year are not likely to accept an invitation to connect or to otherwise be prompted to interact with the online service 100. Therefore, the online service 100 may improve its effectiveness and efficiency in optimizing user interaction with an online service by only boosting recommendations of inactive users that are likely to respond to the prompting to interact with the online service 100 rather than including inactive users that are unlikely to respond.

At operation 430, the online service 100 boosts the score for each user of the set of users using an optimization algorithm with a first constraint and a second constraint to optimize the first objective function, the second objective function, and the third objective function. The first constraint comprises a maximum threshold number of the set of users to display as recommendations to the source user, thereby ensuring that the boosting does not result in too many of the inactive users being displayed as recommendations to the source user. The second constraint comprises a minimum threshold number of the set of users for which the source user to perform the particular source user action, thereby ensuring that the number of inactive users that are displayed as recommendations to the source user is not too small. In some example embodiments, the optimization algorithm comprises linear programming algorithm. However, other types of optimization algorithms are also within the scope of the present disclosure.

At operation 440, the online service 100 selects a subset of the plurality of destination user candidates from the plurality of destination user candidates based on the scores of the plurality of destination user candidates. The selected subset includes at least one user of the set of users based on the boosting of the score of the at least one user of the set of users.

At operation 450, the online service 100 causes a recommendation for each one of the selected subset of the plurality of destination user candidates to be displayed on a computing device of the source user. The recommendation for each one of the selected subset of the plurality of destination user candidates may be displayed concurrently on the computing device. The recommendation comprises a recommendation to perform the particular source user action for the one of the selected subset of destination user candidates.

It is contemplated that any of the other features described within the present disclosure can be incorporated into the method 400.

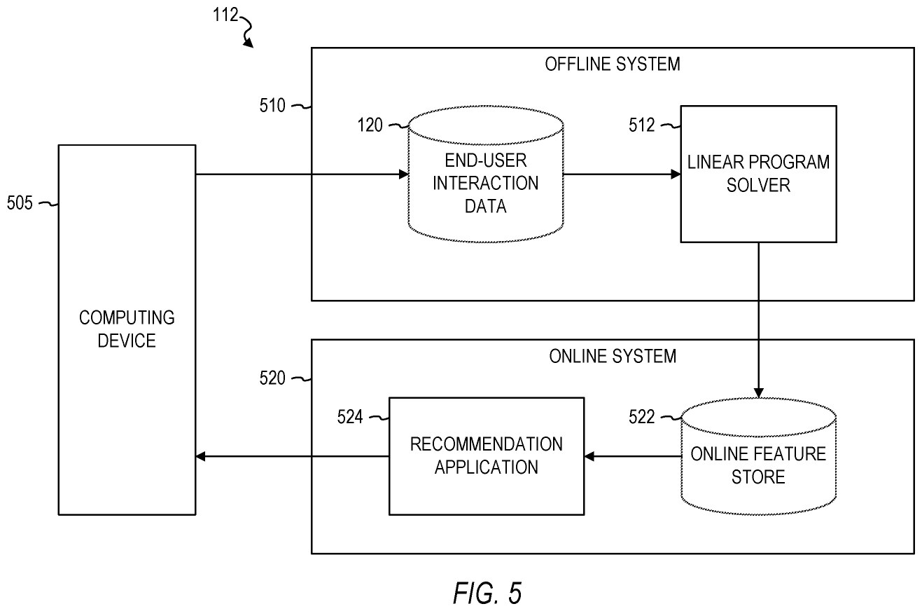

FIG. 5 is a block diagram illustrating an architecture of the recommendation system 112, in accordance with an example embodiment. The recommendation system 112 may comprise an offline system 510 that solves the optimization problem at an enormous scale and an online system 520 that modifies the relevance scores for the source-destination pair according to the duals derived by the offline system 510 and serves the recommendations in real-time to a computing device 505 of the source user.

In some example embodiments, the offline system 510 comprises a linear program solver 512. The linear program solver 512 may be configured to use an optimization algorithm to optimize the first objective function, the second objective function, and the third objective function. The optimization algorithm may comprise a gradient descent algorithm. Gradient descent is a first-order iterative optimization algorithm for finding a local minimum of a differentiable function. The idea is to take repeated steps are taken in the opposite direction of the gradient of the function at the current point because it is the direction of steepest descent.

The offline system 510 may use DuaLip as the linear program solver 512, which is an extreme-scale linear program solver. At a high level, DuaLip makes the underlying linear objective strongly convex by introducing a squared regularization term. Such modification guarantees a Lipschitz continuous gradient, making the optimization amenable to gradient descent methods. The primal solution involves vertex-oriented projection on a polytope inscribing a convex set which provides the necessary efficiency in computations required for large-scale applications. DuaLip uses Nesterov's accelerated gradient descent (AGD) and Limited-memory BFGS-B (LBFGS-B) to update the dual variables. The framework alternately iterates over primal projection and dual ascension to arrive at an optimal solution following the paradigm of typical dual ascension techniques.

In some example embodiments, the linear program solver 512 may solve the original problem at full scale. However, in other example embodiments, in order to reduce the scale of the problem, the recommendation system 112 partitions the inactive users into smaller coherent subsets to solve the optimization problem corresponding to each such subset, and then summarizes the duals obtained using aggregation, such as max-pool or mean-pool. To reduce the size of the problem, the recommendation system 112 may sample the set of inactive users based on their scores. First, a k-means clustering may be performed using the scores of the inactive users as features. Then, for each cluster, the recommendation system 112 may sample a subset of inactive users from the cluster based on the scores of the inactive users. To make the sampling relevant, the recommendation system 112 may select inactive users closer to the centroid of the clusters with a higher probability. The recommendation system 112 may then use this set of inactive users in the optimization framework. After clustering and sampling the inactive users, the recommendation system 112 may impute the dual values of the sampled inactive users of a cluster to the inactive users of the cluster that were not selected in the sampling process based on the premise that inactive users with similar representation in the 10-dimensional feature space have similar dual values.

Since the recommendation system 112 solve the problem for only a small subset of inactive users selected via the clustering and sampling process, the recommendation system 112 may extrapolate the solution to other inactive users not selected in the sampling process. In one example, the offline system 510 parses the interaction data from the database 120, filters information that is pursuant to the optimization formulation, samples the inactive users and prepares the data that needs to be fed to the linear program solver 512, ingests the dual values that the linear program solver 512 derives, and extrapolates these values to all the inactive users who are not selected in the sampling process.

At an imputation stage, the recommendation system 112 may join two large tables—one containing the attributes of the inactive users selected in the sampling process and the other having the attributes of the inactive users not selected in the sampling process. First, the attributes of the smaller table are compared with those in the larger table using squared Euclidean distance. The source users are then grouped by the destination users and ordered by the similarity score, after which the top subset of most similar inactive users are retained from the source table. The recommendation system 112 may then perform a simple averaging of the duals associated with the inactive users from the source table to derive the duals for the inactive users in the destination table.

The online system 520 collects the data from the table consisting of all the duals and pushes them to an online feature store 522, which serves the required duals to a recommendation application 524 during a ranking stage. Note that such ranking is performed on a small subset of users that many candidate generation mechanisms (offline and online) find relevant. Whenever a source user visits the website, the recommendation application 524 is invoked, which subsequently ranks the candidates based on the computed relevance scores. The online implementation ensures that all relevant computations, including fetching the duals from the online feature store 522 and (re)scoring the inactive user candidates, are done within a latency budget (a few tens of milliseconds) acceptable to the overall system.

Certain embodiments are described herein as including logic or a number of components or mechanisms. Components may constitute either software components (e.g., code embodied (1) on a non-transitory machine-readable medium or (2) in a transmission signal) or hardware-implemented components. A hardware-implemented component is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented component that operates to perform certain operations as described herein.

In various embodiments, a hardware-implemented component may be implemented mechanically or electronically. For example, a hardware-implemented component may comprise dedicated circuitry or logic that is permanently configured (e.g., as a special-purpose processor, such as a field programmable gate array (FPGA) or an application-specific integrated circuit (ASIC)) to perform certain operations. A hardware-implemented component may also comprise programmable logic or circuitry (e.g., as encompassed within a programmable processor) that is temporarily configured by software to perform certain operations. It will be appreciated that the decision to implement a hardware-implemented component mechanically, in dedicated and permanently configured circuitry, or in temporarily configured circuitry (e.g., configured by software) may be driven by cost and time considerations.

Accordingly, the term “hardware-implemented component” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented components are temporarily configured (e.g., programmed), each of the hardware-implemented components need not be configured or instantiated at any one instance in time. For example, where the hardware-implemented components comprise a processor configured using software, the processor may be configured as respective different hardware-implemented components at different times. Software may accordingly configure a processor, for example, to constitute a particular hardware-implemented component at one instance of time and to constitute a different hardware-implemented component at a different instance of time.

Hardware-implemented components can provide information to, and receive information from, other hardware-implemented components. Accordingly, the described hardware-implemented components may be regarded as being communicatively coupled. Where multiple of such hardware-implemented components exist contemporaneously, communications may be achieved through signal transmission (e.g., over appropriate circuits and buses) that connect the hardware-implemented components. In embodiments in which multiple hardware-implemented components are configured or instantiated at different times, communications between such hardware-implemented components may be achieved, for example, through the storage and retrieval of information in memory structures to which the multiple hardware-implemented components have access. For example, one hardware-implemented component may perform an operation, and store the output of that operation in a memory device to which it is communicatively coupled. A further hardware-implemented component may then, at a later time, access the memory device to retrieve and process the stored output. Hardware-implemented components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Similarly, the methods described herein may be at least partially processor-implemented. For example, at least some of the operations of a method may be performed by one or more processors or processor-implemented components. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a component, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on target data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

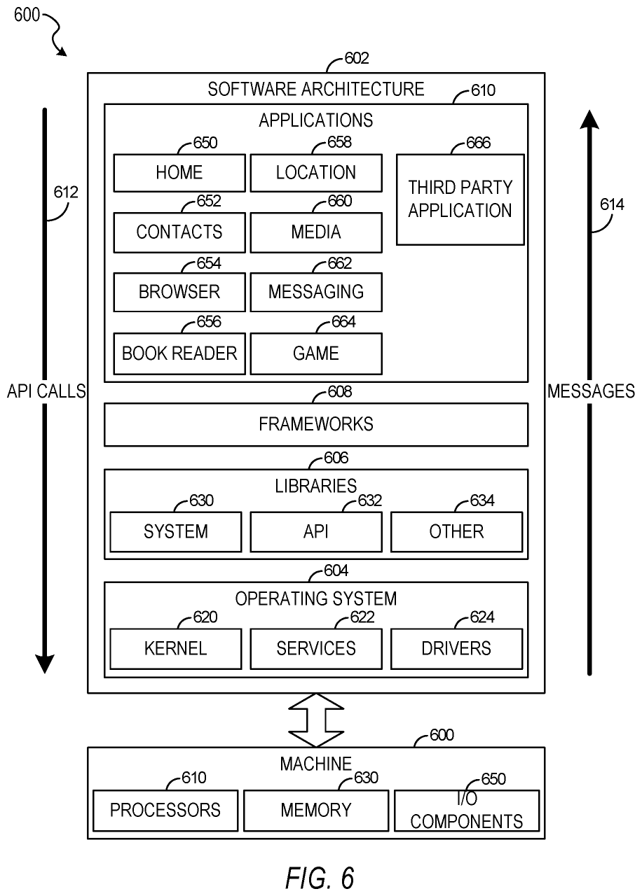

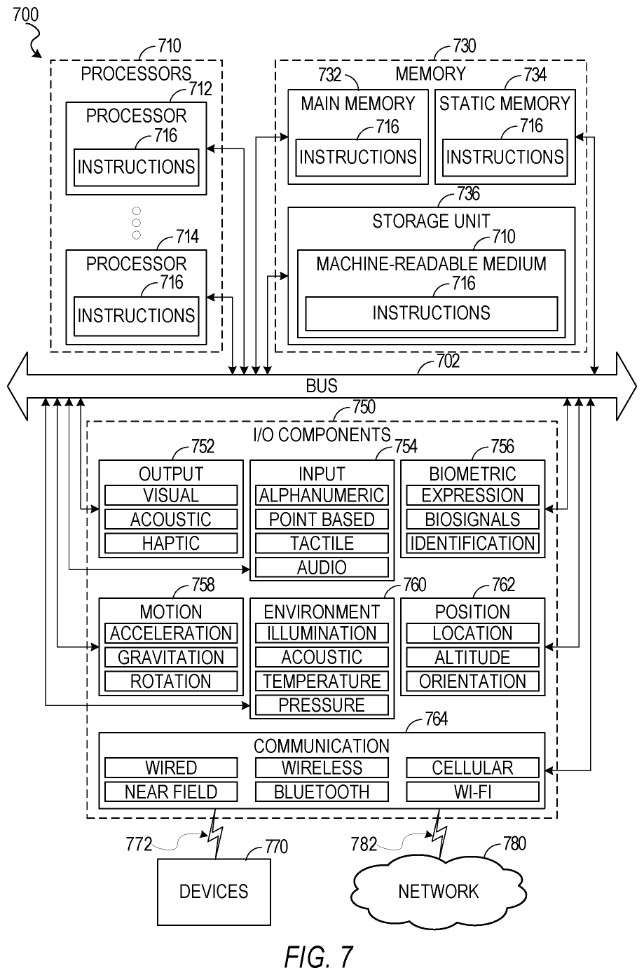

FIG. 6 is a block diagram 600 illustrating a software architecture 602, which can be installed on any one or more of the devices described above. FIG. 6 is merely a non-limiting example of a software architecture, and it will be appreciated that many other architectures can be implemented to facilitate the functionality described herein. In various embodiments, the software architecture 602 is implemented by hardware such as a machine 700 of FIG. 7 that includes processors 610, memory 630, and input/output (I/O) components 650. In this example architecture, the software architecture 602 can be conceptualized as a stack of layers where each layer may provide a particular functionality. For example, the software architecture 602 includes layers such as an operating system 604, libraries 606, frameworks 608, and applications 610. Operationally, the applications 610 invoke API calls 612 through the software stack and receive messages 614 in response to the API calls 612, consistent with some embodiments.

In various implementations, the operating system 604 manages hardware resources and provides common services. The operating system 604 includes, for example, a kernel 620, services 622, and drivers 624. The kernel 620 acts as an abstraction layer between the hardware and the other software layers, consistent with some embodiments. For example, the kernel 620 provides memory management, processor management (e.g., scheduling), component management, networking, and security settings, among other functionality. The services 622 can provide other common services for the other software layers. The drivers 624 are responsible for controlling or interfacing with the underlying hardware, according to some embodiments. For instance, the drivers 624 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 606 provide a low-level common infrastructure utilized by the applications 610. The libraries 606 can include system libraries 630 (e.g., C standard library) that can provide functions such as memory allocation functions, string manipulation functions, mathematic functions, and the like. In addition, the libraries 606 can include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 606 can also include a wide variety of other libraries 634 to provide many other APIs to the applications 610.

The frameworks 608 provide a high-level common infrastructure that can be utilized by the applications 610, according to some embodiments. For example, the frameworks 608 provide various GUI functions, high-level resource management, high-level location services, and so forth. The frameworks 608 can provide a broad spectrum of other APIs that can be utilized by the applications 610, some of which may be specific to a particular operating system 604 or platform.

In an example embodiment, the applications 610 include a home application 650, a contacts application 652, a browser application 654, a book reader application 656, a location application 658, a media application 660, a messaging application 662, a game application 664, and a broad assortment of other applications, such as a third-party application 666. According to some embodiments, the applications 610 are programs that execute functions defined in the programs. Various programming languages can be employed to create one or more of the applications 610, structured in a variety of manners, such as object-oriented programming languages (e.g., Objective-C, Java, or C++) or procedural programming languages (e.g., C or assembly language). In a specific example, the third-party application 666 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 666 can invoke the API calls 612 provided by the operating system 604 to facilitate functionality described herein.

FIG. 7 illustrates a diagrammatic representation of a machine 700 in the form of a computer system within which a set of instructions may be executed for causing the machine 700 to perform any one or more of the methodologies discussed herein, according to an example embodiment. Specifically, FIG. 7 shows a diagrammatic representation of the machine 700 in the example form of a computer system, within which instructions 716 (e.g., software, a program, an application 710, an applet, an app, or other executable code) for causing the machine 700 to perform any one or more of the methodologies discussed herein may be executed. For example, the instructions 716 may cause the machine 700 to execute the method 500 of FIG. 5. Additionally, or alternatively, the instructions 716 may implement FIGS. 1-5, and so forth. The instructions 716 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a PC, a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and I/O components 750, which may be configured to communicate with each other such as via a bus 702. In an example embodiment, the processors 710 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 712 and a processor 714 that may execute the instructions 716. The term “processor” is intended to include multi-core processors 710 that may comprise two or more independent processors 712 (sometimes referred to as “cores”) that may execute instructions 716 contemporaneously. Although FIG. 7 shows multiple processors 710, the machine 700 may include a single processor 712 with a single core, a single processor 712 with multiple cores (e.g., a multi-core processor), multiple processors 710 with a single core, multiple processors 710 with multiple cores, or any combination thereof.

The memory 730 may include a main memory 732, a static memory 734, and a storage unit 736, all accessible to the processors 710 such as via the bus 702. The main memory 732, the static memory 734, and the storage unit 736 store the instructions 716 embodying any one or more of the methodologies or functions described herein. The instructions 716 may also reside, completely or partially, within the main memory 732, within the static memory 734, within the storage unit 736, within at least one of the processors 710 (e.g., within the processor's cache memory), or any suitable combination thereof, during execution thereof by the machine 700.

The I/O components 750 may include a wide variety of components to receive input, provide output, produce output, transmit information, exchange information, capture measurements, and so on. The specific I/O components 750 that are included in a particular machine 700 will depend on the type of machine 700. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion, and the grouping is in no way limiting. In various example embodiments, the I/O components 750 may include output components 752 and input components 754. The output components 752 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762, among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 762 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via a coupling 782 and a coupling 772, respectively. For example, the communication components 764 may include a network interface component or another suitable device to interface with the network 780. In further examples, the communication components 764 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a USB).

Moreover, the communication components 764 may detect identifiers or include components operable to detect identifiers. For example, the communication components 764 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

The various memories (i.e., 730, 732, 734, and/or memory of the processor(s) 710) and/or the storage unit 736 may store one or more sets of instructions 716 and data structures (e.g., software) embodying or utilized by any one or more of the methodologies or functions described herein. These instructions (e.g., the instructions 716), when executed by the processor(s) 710, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 716 and/or data. The terms shall accordingly be taken to include, but not be limited to, solid-state memories, and optical and magnetic media, including memory internal or external to the processors 710. Specific examples of machine-storage media, computer-storage media, and/or device-storage media include non-volatile memory including, by way of example, semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 780 may be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network, and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 716 may be transmitted or received over the network 780 using a transmission medium via a network interface device (e.g., a network interface component included in the communication components 764) and utilizing any one of a number of well-known transfer protocols (e.g., HTTP). Similarly, the instructions 716 may be transmitted or received using a transmission medium via the coupling 772 (e.g., a peer-to-peer coupling) to the devices 770. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 716 for execution by the machine 700, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method performed by a computer system having a memory and at least one hardware processor, the computer-implemented method comprising:
for each one of a plurality of destination user candidates, computing a score using a first objective function based on a probability of a source user performing a particular source user action directed towards the destination user candidate, a second objective function based on a probability of the destination user candidate performing a particular destination user action in response to the particular source user action, and a third objective function based on a predicted measure of interaction by the destination user candidate with an online service to result from the particular destination user action being performed by the destination user candidate;
identifying a set of users from amongst the plurality of destination user candidates based on a determination that an amount of time that has passed since each user of the set of users has interacted with an online service satisfies a minimum threshold value;
boosting the score for each user of the set of users using an optimization algorithm to optimize the first objective function, the second objective function, and the third objective function;
selecting a subset of the plurality of destination user candidates from the plurality of destination user candidates based on the scores of the plurality of destination user candidates, the selected subset including at least one user of the set of users based on the boosting of the score of the at least one user of the set of users; and
causing a recommendation for each one of the selected subset of the plurality of destination user candidates to be displayed on a computing device of the source user, the recommendation comprising a recommendation to perform the particular source user action for the one of the selected subset of destination user candidates.

2. The computer-implemented method of claim 1, wherein the boosting of the score for each user of the set of users comprises boosting the score for the user using the optimization algorithm with a first constraint and a second constraint to optimize the first objective function, the second objective function, and the third objective function, the first constraint comprising a maximum threshold number of the set of users to display as recommendations to the source user, the second constraint comprising a minimum threshold number of the set of users for which the source user to perform the particular source user action.

3. The computer-implemented method of claim 1, wherein the optimization algorithm comprises linear programming algorithm.

4. The computer-implemented method of claim 1, wherein the identifying the set of users from amongst the plurality of destination user candidates is further based on a determination that the amount of time that has passed since each user of the set of users has interacted with the online service satisfies a maximum threshold value.

5. The computer-implemented method of claim 1, wherein the particular source user action comprises submitting an invitation to connect via a social networking service, and the particular destination user action comprises accepting an invitation to connect via the social networking service.

6. The computer-implemented method of claim 1, wherein the probability of the source user performing the particular source user action directed towards the destination user candidate is based on at least one of profile data of the source user, interaction data indicating interactions of the source user with the online service, or social graph data of the source user.

7. The computer-implemented method of claim 1, wherein the probability of the destination user candidate performing the particular destination user action in response to the particular source user action is based on at least one of profile data of the destination user candidate, interaction data indicating interactions of the destination user candidate with the online service, or social graph data of the destination user candidate.

8. The computer-implemented method of claim 1, wherein the predicted measure of interaction by the destination user candidate with the online service to result from the particular destination user action being performed by the destination user candidate is based on a number of sessions between the destination user candidate and the online service within a specified period of time after the particular destination user action was performed by the destination user candidate.

9. A system comprising:
at least one hardware processor; and
a non-transitory machine-readable medium embodying a set of instructions that, when executed by the at least one hardware processor, cause the at least one hardware processor to perform operations, the operations comprising:
for each one of a plurality of destination user candidates, computing a score using a first objective function based on a probability of a source user performing a particular source user action directed towards the destination user candidate, a second objective function based on a probability of the destination user candidate performing a particular destination user action in response to the particular source user action, and a third objective function based on a predicted measure of interaction by the destination user candidate with an online service to result from the particular destination user action being performed by the destination user candidate;
identifying a set of users from amongst the plurality of destination user candidates based on a determination that an amount of time that has passed since each user of the set of users has interacted with an online service satisfies a minimum threshold value;
boosting the score for each user of the set of users using an optimization algorithm to optimize the first objective function, the second objective function, and the third objective function;
selecting a subset of the plurality of destination user candidates from the plurality of destination user candidates based on the scores of the plurality of destination user candidates, the selected subset including at least one user of the set of users based on the boosting of the score of the at least one user of the set of users; and
causing a recommendation for each one of the selected subset of the plurality of destination user candidates to be displayed on a computing device of the source user, the recommendation comprising a recommendation to perform the particular source user action for the one of the selected subset of destination user candidates.

10. The system of claim 9, wherein the boosting of the score for each user of the set of users comprises boosting the score for the user using the optimization algorithm with a first constraint and a second constraint to optimize the first objective function, the second objective function, and the third objective function, the first constraint comprising a maximum threshold number of the set of users to display as recommendations to the source user, the second constraint comprising a minimum threshold number of the set of users for which the source user to perform the particular source user action.

11. The system of claim 9, wherein the optimization algorithm comprises linear programming algorithm.

12. The system of claim 9, wherein the identifying the set of users from amongst the plurality of destination user candidates is further based on a determination that the amount of time that has passed since each user of the set of users has interacted with the online service satisfies a maximum threshold value.

13. The system of claim 9, wherein the particular source user action comprises submitting an invitation to connect via a social networking service, and the particular destination user action comprises accepting an invitation to connect via the social networking service.

14. The system of claim 9, wherein the probability of the source user performing the particular source user action directed towards the destination user candidate is based on at least one of profile data of the source user, interaction data indicating interactions of the source user with the online service, or social graph data of the source user.

15. The system of claim 9, wherein the probability of the destination user candidate performing the particular destination user action in response to the particular source user action is based on at least one of profile data of the destination user candidate, interaction data indicating interactions of the destination user candidate with the online service, or social graph data of the destination user candidate.

16. The system of claim 9, wherein the predicted measure of interaction by the destination user candidate with the online service to result from the particular destination user action being performed by the destination user candidate is based on a number of sessions between the destination user candidate and the online service within a specified period of time after the particular destination user action was performed by the destination user candidate.

17. A non-transitory machine-readable medium embodying a set of instructions that, when executed by at least one hardware processor, cause the at least one hardware processor to perform operations, the operations comprising:
for each one of a plurality of destination user candidates, computing a score using a first objective function based on a probability of a source user performing a particular source user action directed towards the destination user candidate, a second objective function based on a probability of the destination user candidate performing a particular destination user action in response to the particular source user action, and a third objective function based on a predicted measure of interaction by the destination user candidate with an online service to result from the particular destination user action being performed by the destination user candidate;
identifying a set of users from amongst the plurality of destination user candidates based on a determination that an amount of time that has passed since each user of the set of users has interacted with an online service satisfies a minimum threshold value;
boosting the score for each user of the set of users using an optimization algorithm to optimize the first objective function, the second objective function, and the third objective function;
selecting a subset of the plurality of destination user candidates from the plurality of destination user candidates based on the scores of the plurality of destination user candidates, the selected subset including at least one user of the set of users based on the boosting of the score of the at least one user of the set of users; and
causing a recommendation for each one of the selected subset of the plurality of destination user candidates to be displayed on a computing device of the source user, the recommendation comprising a recommendation to perform the particular source user action for the one of the selected subset of destination user candidates.

18. The non-transitory machine-readable medium of claim 17, wherein the boosting of the score for each user of the set of users comprises boosting the score for the user using the optimization algorithm with a first constraint and a second constraint to optimize the first objective function, the second objective function, and the third objective function, the first constraint comprising a maximum threshold number of the set of users to display as recommendations to the source user, the second constraint comprising a minimum threshold number of the set of users for which the source user to perform the particular source user action.

19. The non-transitory machine-readable medium of claim 17, wherein the optimization algorithm comprises linear programming algorithm.

20. The non-transitory machine-readable medium of claim 17, wherein the identifying the set of users from amongst the plurality of destination user candidates is further based on a determination that the amount of time that has passed since each user of the set of users has interacted with the online service satisfies a maximum threshold value.
